(19) United States
(12) Patent Application Publication
(10) Pub. No.: US 2019/0006824 A1
(43) Pub. Date: Jan. 3, 2019

(54) ELECTRICAL DEVICE AND DISTRIBUTION BOARD

(71) Applicant: Panasonic Intellectual Property Management Co., Ltd., Osaka (JP)

(72) Inventors: Tomoaki SASAKI, Mie (JP); Yasuhiro SUMINO, Mie (JP)

(21) Appl. No.: 16/019,861

(22) Filed: Jun. 27, 2018

(30) Foreign Application Priority Data
Jun. 28, 2017 (JP) 2017-126549

(51) Int. Cl. H02B 1/40; H01R 4/34; H01R 9/24; H02B 1/056; H02B 3/00

(52) U.S. Cl. CPC H02B 1/40; H01R 4/34; H01H 9/0264; H02B 1/056; H02B 3/00; H01R 9/24

(57) ABSTRACT

A housing includes a first wall and a second wall. The first wall and the second wall face each other in a first direction. A printed circuit board is accommodated in the housing with one surface of a substrate facing the first wall. The housing has a through hole. The through hole extends from an outer surface through an inner surface of the housing. The through hole is open in the inner surface of the housing along a second direction. The second direction is orthogonal to the first direction.

### CROSS-REFERENCE TO RELATED APPLICATION

The present application is based upon and claims the benefit of priority of Japanese Patent Application No. 2017-126549, filed on Jun. 28, 2017, the entire contents of which are incorporated herein by reference.

### TECHNICAL FIELD

The present disclosure relates to electrical devices and distribution boards. The present disclosure specifically relates to an electrical device including a housing accommodating a printed circuit board and a distribution board including the electrical device.

### BACKGROUND ART

A known example is an electrical device described in JP 2012-059678 A (hereinafter referred to as “Document 1”). The electrical device described in Document 1 includes a housing having a rectangular box shape. The housing accommodates a circuit configured to operate by being externally supplied with electric power.

In the electrical device described in Document 1, however, when gas is generated in the housing, the gas cannot sufficiently be exhausted to outside the housing, which may lead to a pressure rise in the housing. For example, when an overcurrent flows through a circuit due to a short circuit, gas may be generated from a circuit component.

### SUMMARY

It is an object of the present disclosure to provide an electrical device configured to reduce a pressure rise in a housing and a distribution board including the electrical device.

To achieve the object, an electrical device according to one aspect of the present disclosure includes a housing and a printed circuit board. The housing includes a first wall and a second wall. The first wall and the second wall face each other in a first direction. The printed circuit board includes a substrate and a mounting component. The printed circuit board is accommodated in the housing with one surface of the substrate facing the first wall. The housing has a through hole. The through hole extends from an outer surface of the housing through an inner surface of the housing. The through hole is open in the inner surface of the housing along a second direction. The second direction is orthogonal to the first direction.

A distribution board according to one aspect of the present disclosure includes the electrical device and a cabinet. The cabinet accommodates the electrical device.

### BRIEF DESCRIPTION OF DRAWINGS

The figures depict one or more implementation in accordance with the present teaching, by way of example only, not by way of limitations. In the figures, like reference numerals refer to the same or similar elements.

FIG. 1 is an end face view illustrating an electrical device according to one embodiment;

FIG. 2 is an exploded perspective view illustrating the electrical device;

FIG. 3 is an enlarged view illustrating a part circled by a long dashed short dashed line in FIG. 1;

FIG. 4 is a cross-sectional perspective view illustrating a second housing of an electrical device according to one embodiment;

FIG. 5 is a side view illustrating the electrical device;

FIG. 6 is a plan view illustrating the second housing of the electrical device;

FIG. 7 is a front view illustrating the electrical device; and

FIG. 8 is a perspective view illustrating a distribution board according to one embodiment.

### DETAILED DESCRIPTION

(1) Configuration

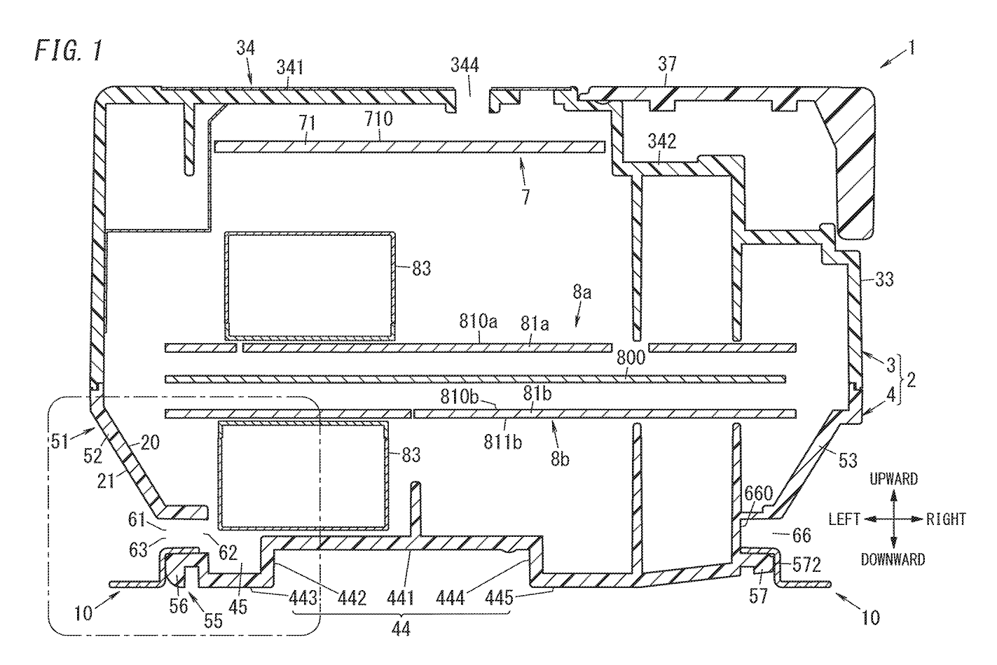

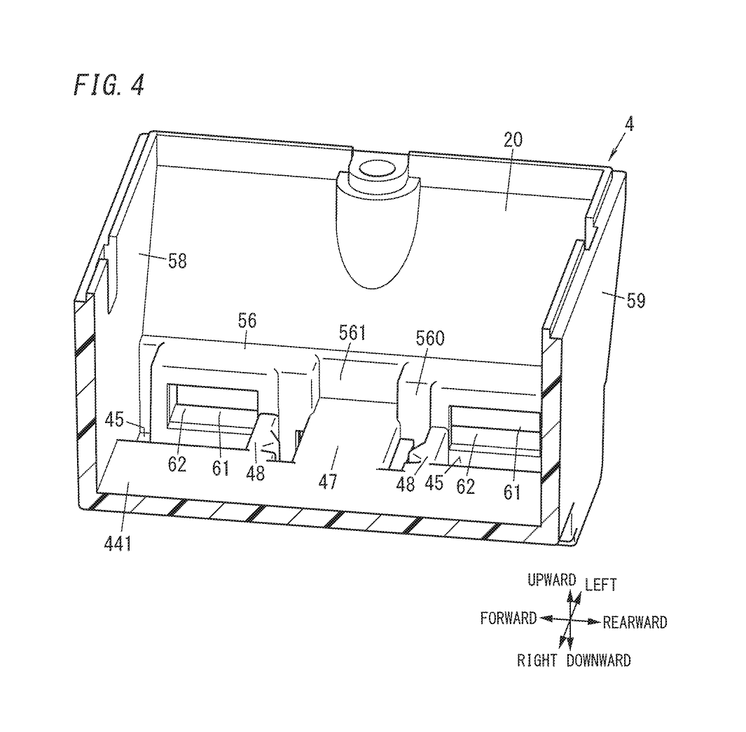

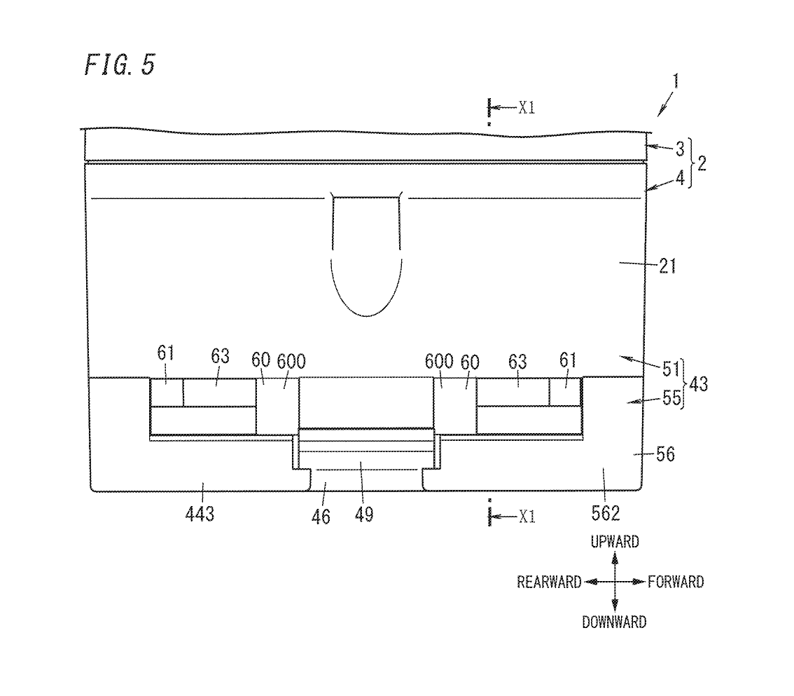

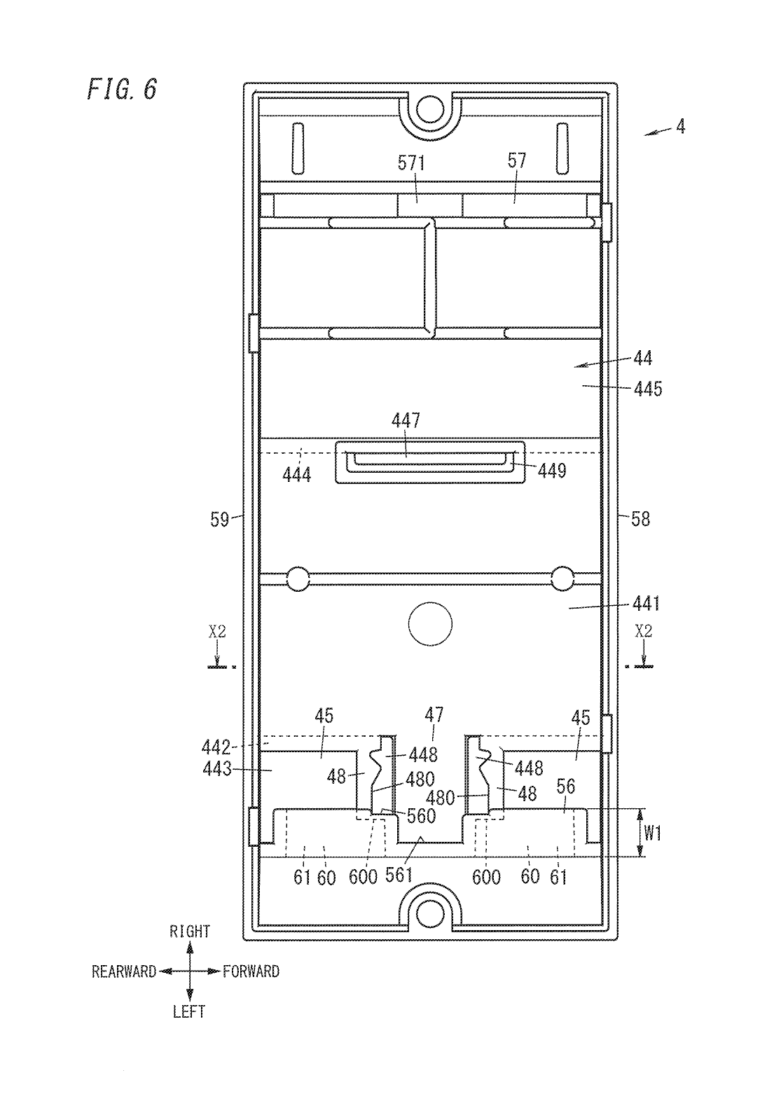

An electrical device and a distribution board according to an embodiment will be described below with reference to the drawings. In the following description, a direction in which a first wall 34 and a second wall 44 face each other in FIG. 1 is defined as the upward and downward direction of an electrical device 1, unless otherwise indicated. Moreover, on a flat surface orthogonal to the direction in which the first wall 34 and the second wall 44 face each other, the longitudinal direction of a housing 2 is defined as the right and left direction of the electrical device 1, and on the flat surface, the short direction (a direction vertical to the surface of the sheet of FIG. 1) of the housing 2 is defined as the forward and rearward direction of the electrical device 1. Note that these directions do not intend to limit directions in which the electrical device 1 is used. FIG. 1 is an end face view illustrating the entirety of the electrical device 1 taken along line X1-X1 in FIG. 5. FIG. 4 is a cross-sectional perspective view taken along line X2-X2 in FIG. 6.

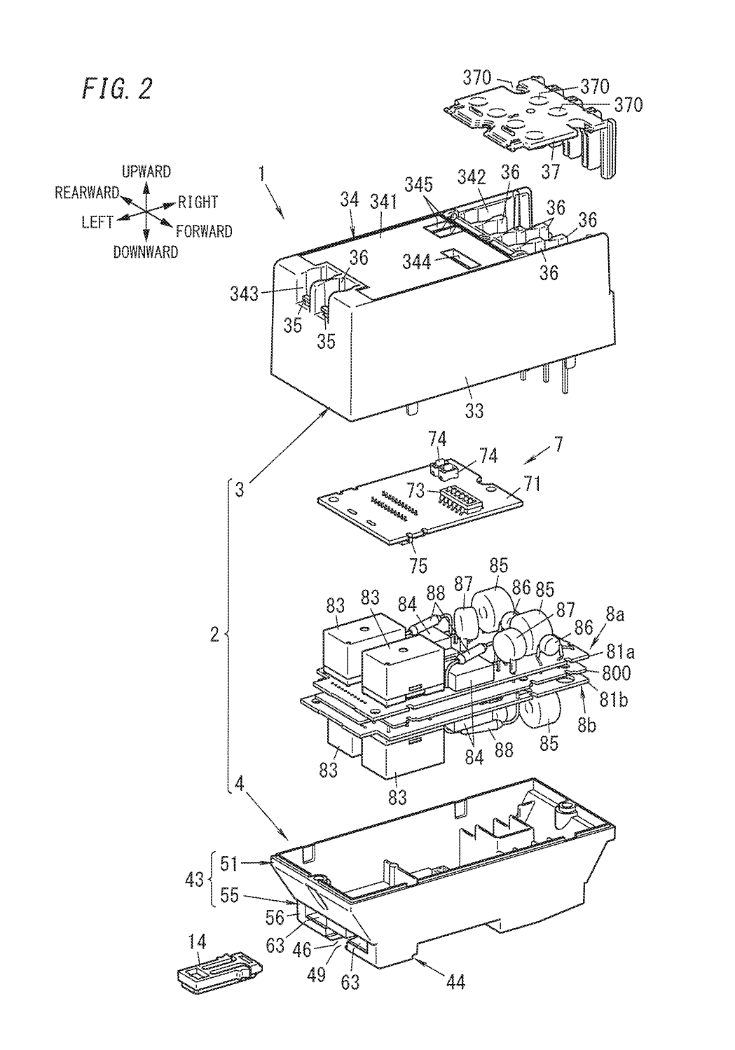

As illustrated in FIGS. 1 and 2, the electrical device 1 of the present embodiment includes the housing 2 and a plurality of(in the figure, three) printed circuit boards 7, 8a, and 8b.

The electrical device 1 of the present embodiment is a relay unit including switching elements such as a mechanical relay 83 and a semiconductor switching device 84. The electrical device 1 receives a control signal from an external apparatus, and based on the control signal, the electrical device 1 individually controls electric power supply to a plurality of (four in the embodiment) external loads. The loads are, for example, lighting fixtures. The control of the electric power supply to the plurality of loads by the electrical device 1 specifically means switching between supplying and interrupting of electric power. The electrical device 1 may further perform dimming control of the plurality of loads (lighting fixtures). The configuration of the electrical device 1 of the present embodiment is accordingly applicable to relay units adopted in other applications. The electrical device 1 is not limited to the relay unit. The configuration of the electrical device 1 of the present embodiment is applicable to various electrical devices including a housing and one or a plurality of printed circuit boards.

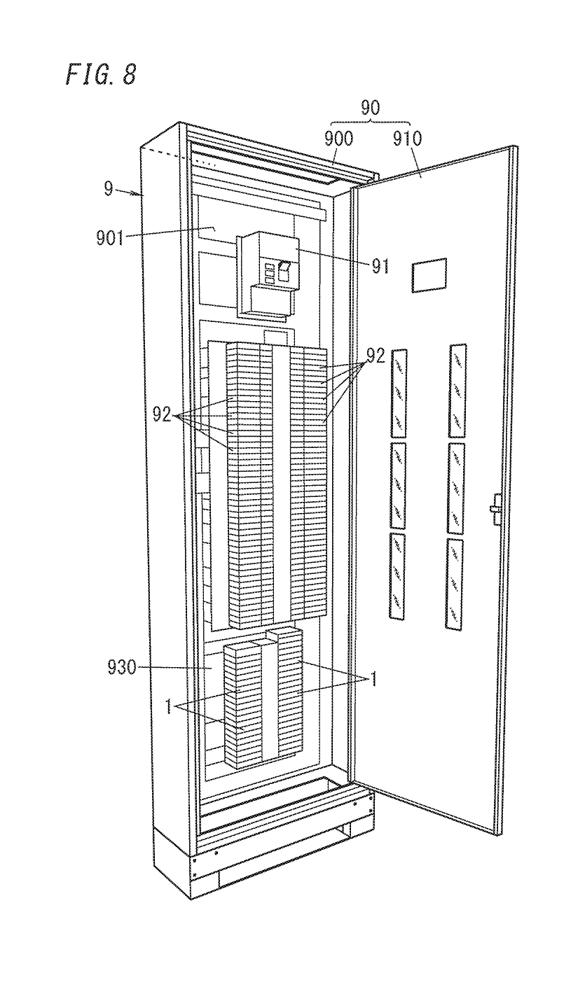

The housing 2 is made of, for example, a synthetic resin as a material. The housing 2 has an electrical insulation property. The outer shape of the housing 2 has, for example, an agreement dimension of distribution board (a dimension defined in JIS standard as a standard for inner devices of a distribution board). The housing 2 is accommodated in a cabinet 90 (see FIG. 8) of a distribution board 9 (see FIG. 8). The cabinet 90 further accommodates a main breaker 91 (see FIG. 8), a branch breaker 92 (see FIG. 8), and the like.

The housing 2 includes a first housing 3 and a second housing 4. The housing 2 is formed by coupling the first housing 3 and the second housing 4. The first housing 3 and the second housing 4 are coupled by means of screws.

The first housing 3 has a shape of a rectangular parallelepiped whose lower surface is open. The first housing 3 includes the first side part 33 and a first wall 34. The first side part 33 and the first wall 34 are formed integrally with each other. The first side part 33 has a tubular shape with an upper surface and a lower surface being rectangular and open. The first wall 34 has a shape elongated in the right and left direction. The first wall 34 covers an upper surface of the first side part 33. The first side part 33 may have a tubular shape with an upper surface and a lower surface being square and open.

The second housing 4 has a box shape with an upper surface being open. The second housing 4 includes a second side part 43 and the second wall 44. The second side part 43 and the second wall 44 are formed integrally with each other. The second side part 43 has a tubular shape. The second wall 44 has a shape elongated in the right and left direction. The second wall 44 covers a lower surface of the second side part 43.

The first housing 3 is coupled to the second housing 4 with a lower end of the first side part 33 (the first housing 3) abutting on an upper end of the second side part 43 (the second housing 4) to form the housing 2. At this time, the first wall 34 and the second wall 44 face each other in a first direction (the upward and downward direction) (see FIG. 1). As used herein, “the first wall 34 and the second wall 44 face each other” is an expression including a case where the first wall 34 and the second wall 44 face each other with another member, for example, the printed circuit board 7, 8a, or 8b, being disposed therebetween.

The first wall 34 includes a first main board 341, a first terminal block 342, and a second terminal block 343. The first main board 341 has a flat plate shape. The first terminal block 342 is formed on the right of the first main board 341. The first terminal block 342 has a step shape. That is, the first terminal block 342 forms a downward step from the first main board 341. The second terminal block 343 is a downwardly recessed left end portion of the first main board 341.

The electrical device 1 further includes a plurality of screw terminals 35 as terminals. The plurality of screw terminals 35 are fixed to the first terminal block 342 and the second terminal block 343. Note that in FIG. 2, only two screw terminals 35 provided to the second terminal block 343 are shown. The plurality of (eight in the embodiment) screw terminals 35 fixed to the first terminal block 342 are connected to four external electric wires to be connected to an external power supply (e.g., a commercial power supply) and four external electric wires for supplying electric power from the external power supply to the plurality of (four) loads. The plurality of (two in the example shown in the figure) screw terminals 35 fixed to the second terminal block 343 are connected to a plurality of (two in the embodiment) signal lines. The two signal lines are external electric wires for transmitting a control signal for turning on and off the mechanical relay 83 and the semiconductor switching device 84 which will be described later.

The first housing 3 further includes a plurality of partitions 36. The plurality of screw terminals 35 fixed to the first terminal block 342 are separated from each other by the plurality of partitions 36 in the forward and rearward direction. In the second terminal block 343, the two screw terminals 35 are separated from each other by the partition 36. Moreover, the electrical device 1 further includes a terminal cover 37 covering the first terminal block 342. The terminal cover 37 has a plurality of pores 370 through which a tool (e.g., a screwdriver) for turning the plurality of screw terminals 35 is to be inserted. The plurality of pores 370 face the plurality of screw terminals 35 fixed to the first terminal block 342.

The second side part 43 includes a body 51 and a leg 55. The body 51 and the leg 55 are formed integrally with each other. The body 51 has a shape of a trapezoid viewed in the forward and rearward direction, wherein the short base of the trapezoid extending in the right and left direction faces downward. The leg 55 is connected to a lower part of the body 51. The leg 55 has a shape of a rectangle whose lower side has a recess viewed in the forward and rearward direction. The shapes of the body 51 and the leg 55 viewed in the forward and rearward direction are continuous in the forward and rearward direction, and the body 51 and the leg 55 are hollow.

As illustrated in FIG. 1, the second wall 44 includes a second main board 441, a left wall 442, a left bottom plate 443, a right wall 444, and a right bottom plate 445. These elements are integrally formed.

The second main board 441 is parallel to the first main board 341. The left wall 442 and the right wall 444 protrude downward respectively from left and right ends of the second main board 441. The left bottom plate 443 protrudes leftward from a lower end of the left wall 442. The right bottom plate 445 protrudes rightward from a lower end of the right wall 444.

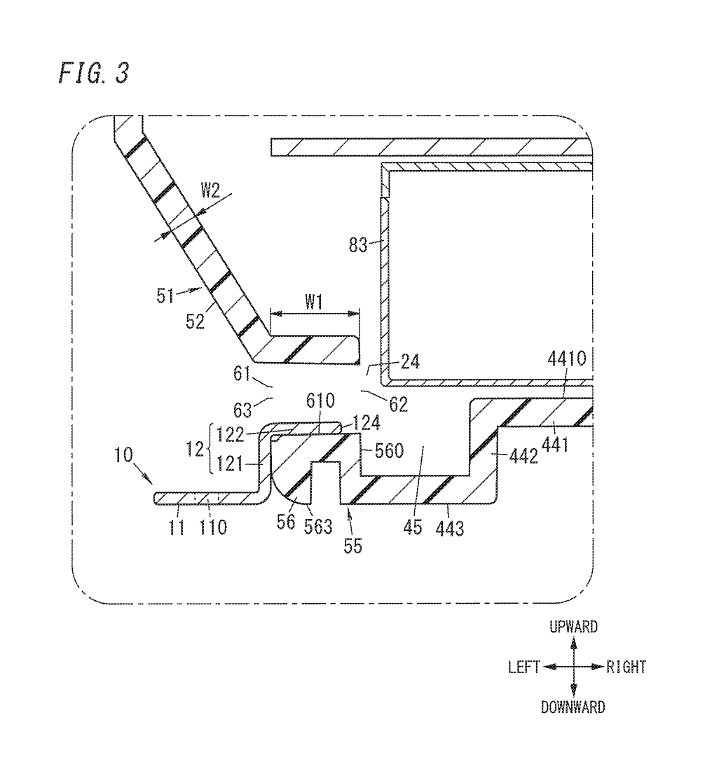

In the body 51, a thickness portion on the left side is referred to as a body wall 52, and a thickness portion on the right side is referred to as a body wall 53. In the leg 55, a thickness portion on the left side is referred to as a leg wall 56, and a thickness portion on the right side is referred to as a leg wall 57. As illustrated in FIG. 4, the leg wall 56 on the left side has an inner surface 560 in which a recess 561 is formed at the center in the forward and rearward direction. As illustrated in FIG. 3, parts of the leg wall 56 on the left side, except for the recess 561, have a thickness W1 larger than a thickness W2 of the body wall 52 on the left side. Moreover, as illustrated in FIG. 6, the leg wall 57 on the right side has a recess 571 formed at the center in the forward and rearward direction. In the leg wall 57, the recess 571 is a downward recess. Parts of the leg wall 57 on the right side, except for the recess 571, have a thickness larger than the thickness of the body wall 53 on the right side (see FIG. 1).

As illustrated in FIGS. 1, 3, 4, and 5, the leg wall 56 (the housing 2) has two through holes 61. Each through hole 61 extends from an inner surface 20 of the housing 2 through an outer surface 21 of the housing 2. That is, the through hole 61 is open in the inner surface 20 and the outer surface 21 of the housing 2. In the example shown in the figures, an inner opening 62 is an area which is part of the inner surface 20 of the housing 2 and in which the through hole 61 is open. An outer opening 63 is an area which is included in the outer surface 21 of the housing 2 and in which the through hole 61 is open.

The outer opening 63 is closer to the second wall 44 than the first wall 34 in the first direction (the upward and downward direction) in which the first wall 34 and the second wall 44 face each other. Moreover, the outer opening 63 is formed in the leg wall 56 which is a portion indented from a periphery to an interior of the housing 2.

The inner opening 62 is formed in the inner surface 560 (see FIG. 4) of the leg wall 56. At the inner opening 62, the housing 2 is open to a space 45 between the leg wall 56 and a set of the left wall 442 and the left bottom plate 443 of the second wall 44 (see FIG. 1). The inner opening 62 faces the left wall 442 (counter section).

Each through hole 61 is open in the inner surface 20 and the outer surface 21 of the housing 2 in a second direction (the right and left direction) orthogonal to the first direction (the upward and downward direction) in which the first wall 34 and the second wall 44 face each other. In other words, the housing 2 is open in the second direction at the inner opening 62 and the outer opening 63. In other words, an inside space of the through hole 61 and an inside space of the housing 2 are in communication with each other in the second direction, and the inside space of the through hole 61 and an outside space of the housing 2 are in communication with each other in the second direction. In this embodiment, the inside space of the housing 2 means a space which is in the housing 2 and which is located more inside than the through hole 61. Moreover, the outside space of the housing 2 means a space which is located outside the opening edge of the through hole 61 of the housing 2.

As illustrated in FIGS. 5 and 6, in the housing 2, the leg wall 56 on the left side has an outer surface 562 having a plurality of (two in the figure) recesses 60. The two recesses 60 correspond to the two through holes 61 on a one-to-one basis. Each through hole 61 includes a space in a corresponding one of the recesses 60. Each through hole 61 is open in a bottom surface 600 of a corresponding one of the recesses 60. That is, the through hole 61 extends from the outer opening 63 through the inside space of the housing 2 to penetrate through the housing 2. In this embodiment, the through hole 61 penetrates through the bottom surface 600 between the outer opening 63 and the inner opening 62 (see FIG. 4) and extends from the outer opening 63 through the inner opening 62. Note that part of the bottom surface 600 remains without being penetrated by the through hole 61. The outer opening 63 corresponds to a part of the recess 60 facing the bottom surface 600 and opening to the outside.

Part of the outer opening 63 and the inner opening 62 face each other in right and left direction through the through hole 61. Thus, the through hole 61 linearly connects the outer opening 63 to the inner opening 62. In other words, the through hole 61 linearly extends from the outer surface 21 through the inner surface 20 of the housing 2. More specifically, the through hole 61 penetrates through the leg wall 56 in the second direction (the right and left direction). The through hole 61 has substantially the same length at anywhere in the upward and downward direction. The through hole 61 has substantially the same length in the forward and rearward direction at anywhere of the through hole 61 between the inner opening 62 and the bottom surface 600 of the recess 60. The through hole 61 has substantially the same length in the forward and rearward direction at anywhere of the through hole 61 between the bottom surface 600 of the recess 60 and the outer opening 63. In the forward and rearward direction, the part of the through hole 61 between the inner opening 62 and the bottom surface 600 of the recess 60 is shorter than the part of the through hole 61 between the bottom surface 600 of the recess 60 and the outer opening 63.

As illustrated in FIG. 1, the leg wall 57 of the leg 55 on the right side has an outer surface 572 having two recesses 66 (only one of which is shown in FIG. 1). The leg wall 57 has no through hole.

The housing 2 is attached to the cabinet 90 (see FIG. 8) of the distribution board 9 (see FIG. 8) by four first attachment members 10 (only two of which is shown in FIG. 1) inserted into the two recesses 60 and the two recesses 66. A method for attaching the housing 2 by the four first attachment members 10 will be described later in detail in “(3) method for Attaching Electrical Device”.

The left bottom plate 443 has an indentation 46 (see FIGS. 2 and 5) at the center in the forward and rearward direction. The indentation 46 divides the left bottom plate 443 in the forward and rearward direction.

As illustrated in FIGS. 4, 5, and 6, the second housing 4 further includes a bridge section 47 and two guide sections 48. The bridge section 47 and the two guide sections 48 bridge the second main board 441 and the leg wall 56. The bridge section 47 is formed at the center of the second wall 44 in the forward and rearward direction. The bridge section 47 is open downward to the outside through the indentation 46. Two spaces 45 facing the two inner openings 62 are disposed in front of and behind the bridge section 47. Each of the two spaces 45 is a downward recess in the second wall 44. One guide section 48 of the two guide sections 48 is formed between the bridge section 47 and one of the spaces 45, and the other guide section 48 is formed between the bridge section 47 and the other space 45. The two guide sections 48 protrude upward from the left bottom plate 443.

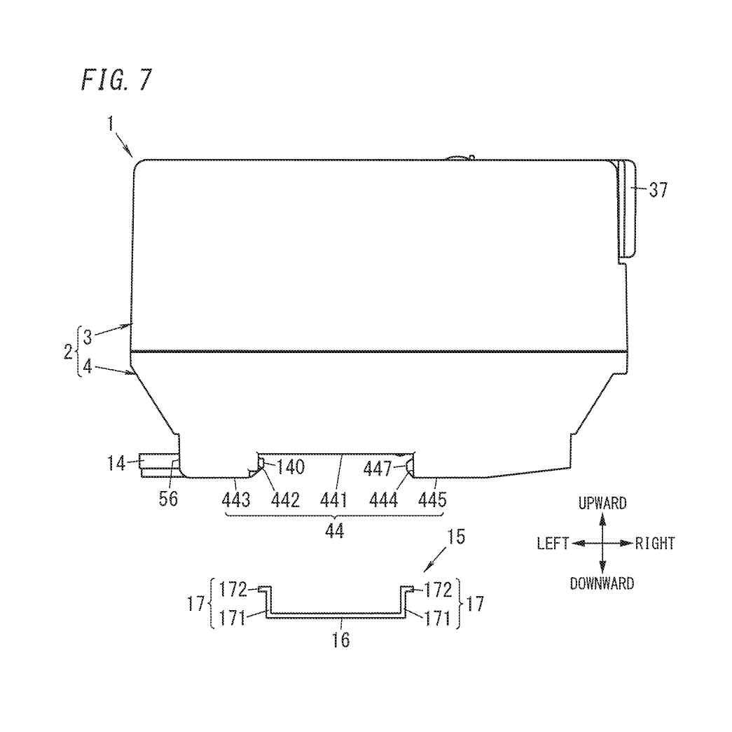

The second housing 4 includes a groove 49 (see FIGS. 2 and 5). The groove 49 is a groove having a bottom surface corresponding to a lower surface of the bridge section 47 and side surfaces corresponding to side surfaces 480 of the two guide sections 48. The side surfaces 480 face each other. The groove 49 is open downward through the indentation 46. The groove 49 penetrates through the leg wall 56 and the left wall 442 in the right and left direction. A fixing member 14 (see FIG. 7) is inserted into the groove 49. The fixing member 14 is held by the two guide sections 48 and is slidable in the right and left direction in the groove 49.

Two first voids 448 (see FIG. 6) each of which is a gap between the bridge section 47 and each guide section 48 is in communication with the groove 49. That is, the interior space of the housing 2 is in communication with the exterior space in the upward and downward direction through the two first voids 448 formed in the second wall 44. Each first void 448 has a shape elongated in the right and left direction.

As illustrated in FIG. 7, a protruding piece 447 protrudes from the right wall 444 of the second wall 44. The protruding piece 447 has a shape elongated in the forward and rearward direction. The housing 2 is fixed to a second attachment member 15 with the second attachment member 15 (DIN rail) being hooked to the protruding piece 447 and the fixing member 14. The method for attaching the housing 2 to the second attachment member 15 will be described in detail later in “(3) Method for Attaching Electrical Device”.

As illustrated in FIG. 6, the second wall 44 has a second void 449. The second void 449 is formed directly above the protruding piece 447. The second void 449 penetrates through the second main board 441 in the upward and downward direction. That is, the interior space of the housing 2 is in communication with the exterior space through the second void 449 in the upward and downward direction. The second void 449 has a shape elongated in the forward and rearward direction and is slightly longer than the protruding piece 447 in the forward and rearward direction.

As illustrated in FIGS. 1 and 2, the printed circuit board 7 includes a substrate 71, a plurality of mounting components mounted on the substrate 71, and a wiring conductor. The printed circuit board 8a includes a substrate 81a, a plurality of mounting components (e.g., two mechanical relays 83 which will be described later) mounted on the substrate 81a, and a wiring conductor. The printed circuit board 8b includes a substrate 81b, a plurality of mounting components (e.g., two mechanical relays 83 which will be described later) mounted on the substrate 81b, and a wiring conductor. In FIG. 1, the plurality of mounting components except for the mechanical relays 83 are omitted.

The three printed circuit boards 7, 8a, and 8b are accommodated in the housing 2. Specifically, the printed circuit board 7 is accommodated in the housing 2 with one surface 710 (upper surface) of the substrate 71 facing the first wall 34. The printed circuit board 8a is accommodated in the housing 2 with one surface 810a (upper surface) of the substrate 81a facing the first wall 34. The printed circuit board 8b is accommodated in the housing 2 with one surface 810b (upper surface) of the substrate 81b facing the first wall 34. As used herein, “the one surfaces 710, 810a, and 810b face the first wall 34” is an expression including a case where each of the one surfaces 710, 810a, and 810b faces the first wall 34 with other members, for example, the plurality of mounting components, disposed between each of the one surfaces 710, 810a, and 810b and the first wall 34.

The substrate 71 is positioned close to the first main board 341 of the first wall 34. The substrates 81a and 81b are positioned around the center of the housing 2 in the upward and downward direction. The substrates 71, 81a, and 81b are positioned by being screwed to the first housing 3.

In the printed circuit board 7, the plurality of mounting components are mounted on the one surface 710 (upper surface) of the substrate 71. Examples of the plurality of mounting components of the printed circuit board 7 include an integrated circuit, a DIP switch 73, two push switches 74, and two connectors 75 (only one of which is shown in FIG. 2). A user manipulates the DIP switch 73 to designate an address of the electrical device 1. An external apparatus other than the electrical device 1 identifies the electrical device 1 based on the address. The DIP switch 73 can be manipulated through a pore 344 formed in the first wall 34. The two push switches 74 can be manipulated through two pores 345 formed in the first wall 34. The two connectors 75 are electrically connected to the wiring conductors of the printed circuit boards 8a and 8b.

In the printed circuit board 8a, the plurality of mounting components are mounted on the one surface 810a (upper surface) of the substrate 81a. In the printed circuit board 8b, the plurality of mounting components are mounted on a lower surface 811b of the substrate 81b. The printed circuit boards 8a and 8b form the same circuits. That is, in each of the printed circuit boards 8a and 8b, the plurality of mounting components include the two mechanical relays 83 (switching elements), the two semiconductor switching devices 84 (switching elements), two inductors 85, two capacitors 86, two varistors 87, two temperature fuses 88, and drive circuits for the semiconductor switching devices 84. Each mechanical relay 83 includes an electrically insulative case accommodating a configuration which includes a contact. Each semiconductor switching device 84 is specifically a triac. The semiconductor switching device 84 may be a thyristor, a metal-oxide-semiconductor field effect transistor (MOSFET), or the like. In FIG. 2, only some of the plurality of mounting components are illustrated.

The printed circuit boards 8a and 8b each include two circuits of hybrid relays including the plurality of mounting components, that is, a total of four circuits are provided. In each of the printed circuit boards 8a and 8b, each of the two hybrid relays includes one mechanical relay 83 and one semiconductor switching device 84. In each hybrid relay, a contact of the mechanical relay 83 and the semiconductor switching device 84 are connected in parallel to each other and establish/interrupt conduction between the external power supply and the load. To supply electric power from the external power supply to the load, the semiconductor switching device 84 is first turned on, so that electric power is started to be supplied from the external power supply toward the load. Then, when the mechanical relay 83 is turned on, the electric power is supplied from the external power supply via the mechanical relay 83 to the load, and the semiconductor-switching device 84 is turned off.

As described below, the hybrid relays are electrically connected to both ends of a series circuit of the load and the external power supply. Two screw terminals 35 of the plurality of (eight) screw terminals 35 fixed to the first terminal block 342 are assigned to each of the plurality of (four) hybrid relays. Each hybrid relay has an input terminal electrically connected to the external power supply via one of the two screw terminals 35 assigned thereto and an output terminal electrically connected to the load via the other of the two screw terminals 35.

The printed circuit board 7 receives a control signal from the external apparatus via the two screw terminals 35 fixed to the second terminal block 343. Based on the control signal, the integrated circuit of the printed circuit board 7 generates, for example, a plurality of (four in the embodiment) signals for individually controlling the plurality of (four) hybrid relays. The integrated circuit transmits the four signals which are generated to the four hybrid relays via the two connectors 75 to switch the respective four hybrid relays. Thus, the electrical device 1 individually turns on and off power supply to the four loads.

The two mechanical relays 83 of the printed circuit board 8b are arranged correspondingly to the two inner openings 62 on a one-to-one basis. Each mechanical relay 83 is provided in the vicinity of a corresponding one of the inner openings 62. In the housing 2, no other members exist in a space between each mechanical relay 83 and the corresponding one of the inner openings 62, and a hollow 24 (see FIG. 3) is thus provided. That is, the electrical device 1 has hollows 24.

The electrical device 1 further includes an insulating plate 800 having an electrical insulation property. The insulating plate 800 is positioned between the substrate 81a and the substrate 81b in parallel to the substrate 81a and the substrate 81b. The substrate 81a, the insulating plate 800, and the substrate 81b are positioned apart from one other.

As illustrated in FIG. 8, the distribution board 9 includes a plurality of the electrical devices 1 and further includes the cabinet 90. Moreover, the distribution board 9 may include the main breaker 91 and the plurality of branch breakers 92. The distribution board 9 may include only one electrical device 1 or two or more electrical devices 1.

The cabinet 90 includes a box 900 and a door 910. The box 900 has a box shape having an opening section 901 in front. The door 910 is attached to the box 900 by a hinge such that the opening section 901 is openable/closeable.

In the longitudinal direction of the cabinet 90, the main breaker 91, the plurality of branch breakers 92, and the plurality of electrical devices 1 are arranged in this order and are accommodated in the cabinet 90. The plurality of electrical devices 1 are attached in the box 900 by the plurality of first attachment members 10 (see FIG. 1) or the second attachment member 15 (see FIG. 7).

(2) Function

When the circuits of the printed circuit boards 7, 8a, and 8b are short circuited due to a failure, or when the electrical device 1 is subjected to a short-circuit test, an overcurrent flows through the circuits of the printed circuit boards 7, 8a, and 8b. Due to the overcurrent, gas may be generated from the mounting components of the printed circuit boards 7, 8a, and 8b. For example, when an overcurrent flows through the contact of the mechanical relay 83, the contact is overheated, and the contact may be disconnected by melting, or gas may be generated from the contact.

The gas generated from the printed circuit boards 7, 8a, and 8b in the housing 2 is exhausted to the outside of the housing 2 through the two through holes 61. This can reduce a pressure rise in the housing 2. Thus, the reliability of the printed circuit boards 7, 8a, and 8b concerning the overcurrent is higher in the electrical device 1 than in a case where the through hole 61 is not provided.

Moreover, in the electrical device 1, the gas generated in the housing 2 can be exhausted through the two first voids 448 and the second void 449.

(3) Method for Attaching Electrical Device

The housing 2 of the electrical device 1 is attached in the cabinet 90 of the distribution board 9 by the four first attachment members 10. Each first attachment member 10 is made of a metal plate. As illustrated in FIGS. 1 and 3, each first attachment member 10 includes a first fixing plate 11 and a first pawl 12. The first fixing plate 11 has a rectangular plate shape or a square plate shape. The first fixing plate 11 has a screw through hole 110. The first pawl 12 includes a rising section 121 and an arm 122 and is hook-shaped. More specifically, the first pawl 12 is an L-shaped plate (a plate having an L-shape when viewed in the forward and rearward direction). The rising section 121 protrudes from one end of the first fixing plate 11 along the thickness direction of the first fixing plate 11. The arm 122 protrudes from an end of the rising section 121 opposite to the first fixing plate 11.

The arms 122 of two first attachment members 10 of the four first attachment members 10 are inserted into the two recesses 60 with the thickness direction of the arms 122 coinciding with the upward and downward direction. The arm 122 has a tip 124 which is in contact with the bottom surface 600 (see FIG. 5) of the recess 60. Thus, the first pawl 12 is hooked to the recess 60. A screw is inserted through the screw through hole 110 with the first pawl 12 being hooked to the recess 60, and the first attachment member 10 is screwed to, for example, a plate material 930 (see FIG. 8) fixed to the cabinet 90 (see FIG. 8).

The two arms 122 of the remaining first attachment members 10 are inserted into the two recesses 66 with the thickness direction of the arms 122 coinciding with the upward and downward direction. The tip 124 of the arm 122 abuts a bottom surface 660 of the recess 66. Thus, the first pawl 12 is hooked to the recess 66. A screw is inserted through the screw through hole 110 with the first pawl 12 being hooked to the recess 66, and the first attachment member 10 is screwed to, for example, a plate material 930 (see FIG. 8) fixed to the cabinet 90 (see FIG. 8).

As described above, the housing 2 is fixed to the four first attachment members 10 on both the right and left sides. Here, the four first fixing plates 11 are closer to the second wall 44 than the first wall 34 in the first direction (the upward and downward direction) in which the first wall 34 and the second wall 44 face each other. Moreover, the housing 2 is fixed to the cabinet 90 via the four first attachment members 10.

The first attachment member 10 corresponds to an attachment member, the first pawl 12 of which is hooked to the housing 2 to fix the housing 2, the first fixing plate 11 corresponds to a fixing plate, and the first pawl 12 corresponds to a pawl. Moreover, the first attachment member 10 also corresponds to an attachment piece, the first pawl 12 of which is hooked to the recess 60 to fix the housing 2, the first fixing plate 11 corresponds to an attachment board, and the first pawl 12 corresponds to a hanging pawl.

The size of the through hole 61 penetrating through the recess 60 in the upward and downward direction is larger than the thickness of the arm 122. Thus, also when the arm 122 is inserted into the recess 60, ventilation of the housing 2 through the through hole 61 between the interior space and the exterior space of the housing 2 is possible.

In the housing 2, the second main board 441 has an upper surface 4410 (see FIG. 3) located above a lower surface 610 of an inner surface of the through hole 61. The left wall 442 (counter section) connects the second main board 441 and the left bottom plate 443 in the upward and downward direction. Thus, the tip 124 of the arm 122 inserted into the through hole 61 (the recess 60) faces the left wall 442. That is, the tip 124 of the arm 122 faces the left wall 442 but not the mounting component and the wiring conductor in the housing 2. The left wall 442 has an electrical insulation property. Thus, electrical insulation between the first attachment member 10 and each of the mounting component and the wiring conductor can be more reliably secured. In particular, the electrical insulation property between the first attachment member 10 and each of the mounting component and the wiring conductor which are not accommodated in a case can be improved.

The method for attaching the housing 2 to the cabinet 90 (see FIG. 8) is not limited to the method using the first attachment members 10. As described below, the housing 2 may be attached by using the second attachment member 15 (see FIG. 7). The second attachment member 15 is a DIN rail standardized by German Institute for Standardization (DIN).

The second attachment member 15 is made of a metal plate. As illustrated in FIG. 7, the second attachment member 15 includes a second fixing plate 16 and two second pawls 17. The second fixing plate 16 has a rectangular plate shape elongated in the forward and rearward direction. Each second pawl 17 includes a rising section 171 and an arm 172 and is hook-shaped. Specifically, the second pawl 17 is an L-shaped plate. The two rising sections 171 of the two second pawls 17 protrude from both right and left ends of the second fixing plate 16 along the thickness direction of the second fixing plate 16. In each second pawl 17, the arm 172 protrudes from an end of the rising section 171 opposite to the second fixing plate 16. The arm 172 of the second pawl 17 on the right side protrudes rightward, and the arm 172 of the second pawl 17 on the left side protrudes leftward.

The fixing member 14 inserted in the groove 49 (see FIG. 2) has a right end 140 protruding into a space between the left wall 442 and the right wall 444 and facing the protruding piece 447 in the right and left direction. The two arms 172 of the second attachment member 15 are hooked to the fixing member 14 and the protruding piece 447, thereby fixing the housing 2 to the second attachment member 15. Moreover, the second attachment member 15 is attached to the cabinet 90 (see FIG. 8) via, for example, a plate material 930 (see FIG. 8).

When the housing 2 is fixed to the second attachment member 15 as described above, the second fixing plate 16 is closer to the second wall 44 than the first wall 34 in the first direction (the upward and downward direction) in which the first wall 34 and the second wall 44 face each other. Moreover, the housing 2 is fixed to the cabinet 90 via the second attachment member 15.

(4) Variations

Variations of the present embodiment will be listed below. The variations described below may be realized accordingly in combination.

The through hole 61 may also be formed in at least one of the two recesses 66 on the right side in addition to the two recesses 60 on the left side.

The through holes 61 may have different length in the upward and downward direction depending on parts of the through hole 61 or may have the same length at all the parts in the upward and downward direction. The through holes 61 may have different length in the forward and rearward direction depending on the parts of the through hole 61 or may have the same length at all the parts in the forward and rearward direction. For example, the through hole 61 may be linear. Alternatively, the through hole 61 may be tapered.

The through hole 61 does not have to penetrate through the housing 2 in the right and left direction. For example, the through hole 61 may have a linear shape extending obliquely upward or obliquely downward along the right and left direction. The through hole 61 may have, for example, an arc shape or a crank shape instead of the linear shape.

The through hole 61 may be formed along the forward and rearward direction. For example, the through hole 61 may be formed at least one of the front wall 58 and the rear wall 59 (see FIG. 6) which are front and rear thickness portions of the leg 55 in the forward and rearward direction.

The through hole 61 is open at least in the inner surface 20 of the housing 2 along a second direction (e.g., the right and left direction or the forward and rearward direction) orthogonal to a first direction (e.g., the upward and downward direction) in which the first wall 34 and the second wall 44 face each other. The direction along the second direction is preferably a direction which intersects the second direction at an angle smaller than 45 degrees. The direction along the second direction is more preferably a direction which intersects the second direction at an angle smaller than 20 degrees. The direction along the second direction is much more preferably a direction parallel to the second direction.

The through hole 61 may be open in the outer surface 21 of the housing 2 in a direction different from the direction (in the first embodiment, the right and left direction) in which the through hole 61 opens in the inner surface 20. For example, the through hole 61 may be open in the inner surface 560 of the leg wall 56 similarly to the first embodiment and be open in the lower surface 563 (see FIG. 3) of the leg wall 56 differently from the first embodiment. That is, for example, the through hole 61 may be open in the inner surface 20 of the housing 2 in the right and left direction and open in the outer surface 21 in the upward and downward direction.

Moreover, the through hole 61 does not have to be formed in the recess 60. The through hole 61 may be formed in, for example, the recess 561 of the leg wall 56 in which the recess 60 is not formed. Alternatively, the through hole 61 may be formed in the second wall 44, in the leg wall 57 on the right side, in the body 51, or in the first housing 3.

Moreover, the number of through holes 61 is not limited to two, but one or three or more through holes 61 may be provided. Moreover, when a plurality of through holes 61 are provided, the plurality of through holes 61 may be formed in different components, for example, through holes 61 may be formed in the first housing 3 and second housing 4.

Moreover, the substrates 71, 81a, and 81b are rigid substrates. However, the substrates 71, 81a, and 81b are not limited to the rigid substrates but may be flexible substrates.

Moreover, the one surfaces 710, 810a, and 810b of all the substrates 71, 81a, and 81b do not have to face the first wall 34. That is, the one surface of at least one substrate faces the first wall 34. Moreover, the number of printed circuit boards may be one, two, or four or more.

Moreover, the printed circuit boards 8a and 8b may include only the mechanical relays 83 as switching elements or only the semiconductor switching devices 84 as switching elements.

Moreover, the configuration of the counter section facing the tip 124 of the first pawl 12 is not limited to the left wall 442. For example, a configuration which protrudes from the left wall 442, the left bottom plate 443, the front wall 58, or the rear wall 59 into the space 45 to face the tip 124 may be added as a counter section.

Moreover, a terminal to which an external electric wire is to be connected is not limited to the screw terminal 35. For example, instead of the screw terminal 35, a terminal which connects the external electric wire by a spring may be used, or a pin terminal or a connector terminal may be used.

(5) Summary

As described above, an electrical device 1 according to a first aspect includes a housing 2 and a printed circuit board 7 (or 8a or 8b). The housing 2 includes a first wall 34 and a second wall 44. The first wall 34 and the second wall 44 face each other in a first direction (the upward and downward direction). The printed circuit board 7 (or 8a or 8b) includes a substrate 71 (or 81a or 81b) and a mounting component (e.g., a mechanical relay 83). The printed circuit board 7 (or 8a or 8b) is accommodated in the housing 2 with one surface 710 (or 810a or 810b) of the substrate 71 (or 81a or 81b) facing the first wall 34. The housing 2 has a through hole 61. The through hole 61 extends from an outer surface 21 through an inner surface 20 of the housing 2. The through hole 61 is open in the inner surface 20 of the housing 2 along a second direction (the right and left direction). The second direction is orthogonal to the first direction.

With this configuration, the housing 2 has the through hole 61 extending from the outer surface 21 through the inner surface 20, and the through hole 61 is open in the inner surface 20 of the housing 2 along the second direction (the right and left direction) orthogonal to the first direction (upward and downward direction) in which the first wall 34 and the second wall 44 of the housing 2 face each other. Thus, when gas is generated in the housing 2, the gas is exhausted through the through hole 61, which enables a pressure rise in the housing 2 to be reduced.

In an electrical device 1 according to a second aspect referring to the first aspect, the through hole 61 is open in the outer surface 21 of the housing 2 along the second direction (the right and left direction).

With this configuration, the through hole 61 is open in the outer surface 21 of the housing 2 along the second direction (the right and left direction). That is, the through hole 61 is open in the inner surface 20 and the outer surface 21 of the housing 2 along an identical second direction. This enables the gas generated in the housing 2 to be more smoothly exhausted.

In an electrical device 1 according to a third aspect referring to the first or second aspect, the through hole 61 linearly extends from the outer surface 21 through the inner surface 20 of the housing 2.

With this configuration, the through hole 61 linearly extends from the outer surface 21 through the inner surface 20 of the housing 2. This enables the gas generated in the housing 2 to be more smoothly exhausted.

In an electrical device 1 according to a fourth aspect referring to any one of the first to third aspects, the printed circuit board 7 (or 8a or 8b) includes a switching element (e.g., the mechanical relay 83 or a semiconductor switching device 84) as the mounting component.

With this configuration, the printed circuit board 7 (or 8a or 8b) includes the switching element (e.g., the mechanical relay 83 or the semiconductor switching device 84) as the mounting component. Since the housing 2 has the through hole 61, heat generated by the switching element can be exhausted through the through hole 61.

An electrical device 1 according to a fifth aspect referring to the fourth aspect, the switching element is the mechanical relay 83.

With this configuration, the switching element is the mechanical relay 83. Since the housing 2 has the through hole 61, gas generated due to overheating of a contact of the mechanical relay 83 by an overcurrent can be exhausted through the through hole 61.

In an electrical device 1 according to a sixth aspect referring to the fourth or fifth aspect, the housing 2 has a hollow 24 provided between the switching element (e.g., the mechanical relay 83 or the semiconductor switching device 84) and an area which is part of the inner surface 20 of the housing 2 and in which the through hole 61 is open.

With this configuration, the electrical device 1 has the hollow 24 between an opening (an inner opening 62) in the inner surface 20 of the housing 2 and the switching element (e.g., the mechanical relay 83 or the semiconductor switching device 84) in the housing 2. Thus, heat generated from the switching element can more effectively be discharged. Moreover, when the switching element is the mechanical relay 83, gas generated from the mechanical relay 83 can be more efficiency exhausted.

In an electrical device 1 according to the seventh aspect referring to any one of the first to sixth aspect, the outer surface 21 of the housing 2 has a recess 60. The housing 2 is fixable to an attachment piece (a first attachment member 10). The attachment piece includes an attachment board (a first fixing plate 11) and a hanging pawl (a first pawl 12). The hanging pawl protrudes from the attachment board and is hook-shaped. Hooking the hanging pawl of the attachment piece to the recess 60 enables the housing 2 to be fixed to the attachment piece. The through hole 61 is open in a bottom surface 600 of the recess 60.

With this configuration, the outer surface 21 of the housing 2 has the recess 60. The hanging pawl (the first pawl 12) of the attachment piece (the first attachment member 10) is to be hooked to the recess 60. The through hole 61 is open in the bottom surface 600 of the recess 60. That is, in the housing 2, the recess 60 to which the hanging pawl is to be hooked and the through hole 61 through which gas generated from the printed circuit board 7 (or 8a or 8b) is to be exhausted are formed at an identical location. Thus, the structure of the housing 2 can be more simplified than that in a case where the recess 60 and the through hole 61 are formed at different locations.

In an electrical device 1 according to an eighth aspect referring to the seventh aspect, the housing further includes a counter section (a left wall 442) therein. The counter section has an electrical insulation property. The counter section faces a tip 124 of the hanging pawl (the first pawl 12).

With this configuration, an electrically insulative counter section (the left wall 442) facing the tip 124 of the hanging pawl (first pawl 12) is disposed in the housing 2. Thus, also when an attachment piece (the first attachment member 10) has a conductive property, electrical insulation between the circuit of the printed circuit board 7 (or 8a or 8b) and the attachment piece can be more reliably secured.

An electrical device 1 according to a ninth aspect referring to any one of the first to eighth aspects, the housing 2 includes a first housing 3 and a second housing 4. The first housing 3 includes the first wall 34. The second housing 4 includes the second wall 44. The second housing 4 is coupled to the first housing 3.

With this configuration, the housing 2 includes the first housing 3 and the second housing 4 coupled to each other, and thus forming of the housing 2 is easier than integrally molding of the first housing 3 and the second housing 4.

An electrical device 1 according to a tenth aspect referring to any one of first to ninth aspects further includes a terminal (a screw terminal 35). The terminal is fixed to the first wall 34. To the terminal, an external electric wire is to be connected. The outer surface 21 of the housing 2 has an area in which the through hole 61 is open and which is closer to the second wall 44 than the first wall 34 in the first direction (the upward and downward direction).

With this configuration, in the first direction (the upward and downward direction), the opening (outer opening 63) in the outer surface 21 of the housing 2 is closer to the second wall 44 than the first wall 34 to which the terminal (the screw terminal 35) is fixed. Thus, the opening in the outer surface 21 is less visible when viewed from the terminal, and therefore, the influence of providing the opening in the outer surface 21 over the external appearance of the housing 2 can be reduced.

In an electrical device 1 according to an eleventh aspect referring to any one of the first to tenth aspects, the housing 2 is fixable to an attachment member (the first attachment member 10 or a second attachment member 15). The attachment member includes a fixing plate (the first fixing plate 11 or a second fixing plate 16) and a pawl (the first pawl 12 or a second pawl 17). The pawl protrudes from the fixing plate and is hook-shaped. The housing 2 is fixable to the attachment member with the pawl of the attachment member being hooked to the housing 2. The fixing plate is closer to the second wall 44 than the first wall 34 in the first direction (the upward and downward direction) with the housing 2 being fixed to the attachment member. In the first direction, an area which is included in the outer surface 21 of the housing 2 and in which the through hole 61 is open is closer to the second wall 44 than the first wall 34.

With this configuration, the housing 2 is fixable to an attachment member (the first attachment member 10 or the second attachment member 15), and in the first direction (the upward and downward direction), the fixing plate (the first fixing plate 11 or the second fixing plate 16) of the attachment member is closer to the second wall 44 than the first wall 34. Moreover, in the first direction, an opening (the outer opening 63) in the outer surface 21 of the housing 2 is closer to the second wall 44 than the first wall 34. Thus, the opening in the outer surface 21 is less visible when viewed from the first wall 34, and therefore, the influence of providing the opening in the outer surface 21 over the external appearance of the housing 2 can be reduced.

A distribution board 9 according to a twelfth aspect includes the electrical device 1 according to any one of the first to eleventh aspects and a cabinet 90. The cabinet 90 accommodates the electrical device 1.

With this configuration, in the electrical device 1 included in the distribution board 9, the housing 2 has a through hole 61 extending from the outer surface 21 through the inner surface 20, and the through hole 61 is open in the inner surface 20 of the housing 2 along the second direction (the right and left direction) orthogonal to the first direction (upward and downward direction) in which the first wall 34 and the second wall 44 of the housing 2 face each other. Thus, when gas is generated in the housing 2, the gas is exhausted through the through hole 61, which can reduce a pressure rise in the housing 2.

The configurations according to second to eleventh aspects are not essential to the electrical device 1 and may accordingly be omitted.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. An electrical device, comprising:
a housing including a first wall and a second wall facing each other in a first direction; and
a printed circuit board including a substrate and a mounting component and accommodated in the housing with one surface of the substrate facing the first wall,
the housing having a through hole extending from an outer surface of the housing through an inner surface of the housing,
the through hole being open in the inner surface of the housing along a second direction orthogonal to the first direction.

2. The electrical device according to claim 1, wherein
the through hole is open in the outer surface of the housing along the second direction.

3. The electrical device according to claim 1, wherein
the through hole linearly extends from the outer surface through the inner surface of the housing.

4. The electrical device according to claim 2, wherein
the through hole linearly extends from the outer surface through the inner surface of the housing.

5. The electrical device according to claim 1, wherein
the printed circuit board includes a switching element as the mounting component.

6. The electrical device according to claim 2, wherein
the printed circuit board includes a switching element as the mounting component.

7. The electrical device according to claim 3, wherein
the printed circuit board includes a switching element as the mounting component.

8. The electrical device according to claim 4, wherein
the printed circuit board includes a switching element as the mounting component.

9. The electrical device according to claim 5, wherein
the switching element is a mechanical relay.

10. The electrical device according to claim 6, wherein
the switching element is a mechanical relay.

11. The electrical device according to claim 7, wherein
the switching element is a mechanical relay.

12. The electrical device according to claim 8, wherein
the switching element is a mechanical relay.

13. The electrical device according to claim 5, wherein
the housing has a hollow provided between the switching element and an area which is included in the inner surface of the housing and in which the through hole is open.

14. The electrical device according to claim 9, wherein
in the housing, a hollow is provided between the switching element and an area which is included in the inner surface of the housing and in which the through hole is open.

15. The electrical device according to claim 1, wherein
the outer surface of the housing has a recess,
the housing is fixable to an attachment piece including an attachment board and a hanging pawl with the hanging pawl being hooked to the recess, the hanging pawl protruding from the attachment board and being hook-shaped,
the through hole is open in a bottom surface of the recess.

16. The electrical device according to claim 15, wherein
the housing further includes a counter section therein, and
the counter section has an electrical insulation property and faces a tip of the hanging pawl.

17. The electrical device according to claim 1, wherein
the housing includes
a first housing including the first wall and
a second housing including the second wall and coupled to the first housing.

18. The electrical device according to claim 1, further comprising:
a terminal which is fixed to the first wall and to which an external electric wire is to be connected, wherein
the outer surface of the housing has an area in which the through hole is open and which is closer to the second wall than the first wall in the first direction.

19. The electrical device according to claim 1, wherein
the housing is fixable to an attachment member including a fixing plate and a pawl with the pawl of the attachment member being hooked to the housing, the pawl protruding from the fixing plate and being hook-shaped,
the fixing plate is closer to the second wall than the first wall in the first direction with the housing being fixed to the attachment member, and
in the first direction, an area which is included in the outer surface of the housing and in which the through hole is open is closer to the second wall than the first wall.

20. A distribution board, comprising:
the electrical device according to claim 1; and
a cabinet accommodating the electrical device.
